(19) United States
(12) Patent Application Publication
(10) Pub. No.: US 2024/0103433 A1
(43) Pub. Date: Mar. 28, 2024

(54) AIR INTAKE STRUCTURE AND IMAGE FORMING APPARATUS

(71) Applicant: FUJIFILM Business Innovation Corp, Tokyo (JP)

(72) Inventors: Kazunari ISHII, Kanagawa (JP); Takahiro ABE, Kanagawa (JP); Yuka Nomura, Kanagawa (JP)

(73) Assignee: FUJIFILM Business Innovation Corp., Tokyo (JP)

(21) Appl. No.: 18/184,665

(22) Filed: Mar. 16, 2023

(30) Foreign Application Priority Data
Sep. 15, 2022 (JP) 2022-146754

(51) Int. Cl. G03G 21/20

(52) U.S. Cl. CPC G03G 21/206

(57) ABSTRACT

An air intake structure includes a blower, a flow path that includes an inlet port that draws air and a flow path space connected to the inlet port to allow air drawn in through the inlet port to flow to the blower, and a recessed portion that protrudes to an outer side of the flow path space at a portion of the flow path adjacent to the inlet port, the recessed portion having a recessed space opening to the flow path space.

### CROSS-REFERENCE TO RELATED APPLICATIONS

This application is based on and claims priority under 35 USC 119 from Japanese Patent Application No. 2022-146754 filed Sep. 15, 2022.

### BACKGROUND

### (i) Technical Field

The present disclosure relates to an air intake structure and an image forming apparatus.

### (ii) Related Art

Japanese Unexamined Patent Application Publication No. 2005-271314 (claim 1 and FIG. 6) describes an atmosphere adjusting system that includes an air flow forming member that ejects ink through an outlet port and forms an air flow near a recording member that performs recording on a recording medium. The atmosphere adjusting system adjusts at least one of the humidity and an ink mist content in air near the outlet port.

In the atmosphere adjusting system described in Japanese Unexamined Patent Application Publication No. 2005-271314 (claim 1 and FIG. 6), the air flow forming member also includes an air flow path that is disposed adjacent to the recording member and that has at least one opening that allows air near the outlet port to flow therethrough, and a stopper that prevents droplets that are to flow downward in the gravitational direction over the wall surface of the flow path from dripping through the opening.

Japanese Patent No. 5562016 (claim 1 and FIG. 4) describes a printing device including a print unit including a print head that ejects ink, and a suction mechanism including a duct and a fan. The suction mechanism draws gas from a space near the print unit through the duct with rotation of the fan.

In the printing device described in Japanese Patent No. 5562016 (claim 1 and FIG. 4), the duct has a nonlinear flow path between an inlet and an outlet, and the flow path has a nonlinear cross section that at least partially surrounds either one or both of the inlet and the outlet. Around at least the outer circumference of the nonlinear flow path, multiple protrusions for trapping ink mist contained in the gas are disposed.

Japanese Patent No. 5068295 (claim 1 and FIG. 1) describes a dryer that includes a circuit including a ventilation duct and a cooling duct. A portion between the ventilation duct and the cooling duct is formed from a communicating duct with an internal surface at least part of which enhances fluid resistance. The communicating duct has a curve. An inner surface of the communicating duct at the outer side of the curve has a shape of bellows, whereas an inner surface of the communicating duct at the inner side of the curve has a shape not having bellows.

### SUMMARY

Aspects of non-limiting embodiments of the present disclosure relate to an air intake structure and an image forming apparatus that reduce transportation, through a blower, of either one or both of water vapor and dust contained in air drawn through an inlet port of a flow path connected to the blower further than a structure not including, at a predetermined position of the flow path, a recessed portion having a recessed space that opens to the flow path space or a protrusion having a slope inclined toward an upstream side of a flow of air drawn in through the inlet port.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an air intake structure comprising: a blower, a flow path that includes an inlet port that draws air and a flow path space connected to the inlet port to allow air drawn in through the inlet port to flow to the blower; and a recessed portion that protrudes to an outer side of the flow path space at a portion of the flow path adjacent to the inlet port, the recessed portion having a recessed space opening to the flow path space.

### BRIEF DESCRIPTION OF THE DRAWINGS

Exemplary embodiments of the present disclosure will be described in detail based on the following figures, wherein:

FIG. 1A is a schematic diagram of an air intake structure according to a first exemplary embodiment, and FIG. 1B is a schematic partially cross-sectional view of the air intake structure in FIG. 1A taken along line IB-IB;

FIG. 2A is an enlarged schematic diagram of the air intake structure in FIG. 1B, and FIG. 2B includes a schematic partially cross-sectional view and a schematic front view of a recessed portion in the air intake structure in FIG. 2A;

FIG. 3 is a schematic diagram of the operation state of the air intake structure in FIG. 1B;

FIG. 4A includes a schematic partially cross-sectional view and a schematic front view of a recessed portion according to a modification for the recessed portion in FIG. 2B, and FIG. 4B is a schematic partially cross-sectional view of the operation state of the recessed portion according to the modification in FIG. 4A;

FIG. 5 is a schematic diagram of an air intake structure according to a second exemplary embodiment;

FIG. 6A is a schematic diagram of an air intake structure according to a third exemplary embodiment, and FIG. 6B is a schematic partially cross-sectional view of the air intake structure in FIG. 6A taken along line VIB-VIB;

FIG. 7A is an enlarged schematic diagram of the air intake structure in FIG. 6B, and FIG. 7B includes a schematic partially cross-sectional view and a schematic front view of a protrusion in the air intake structure in FIG. 7A;

FIG. 8 is a schematic diagram of the air intake structure in FIG. 6B in the operation state;

FIG. 9 is a schematic diagram of an air intake structure according to a fourth exemplary embodiment;

FIG. 10A is a schematic front view of an image forming apparatus according to a fifth exemplary embodiment, and FIG. 10B is a schematic left-side view of the image forming apparatus in FIG. 10A;

FIG. 11 is a schematic diagram of an internal structure of the image forming apparatus in FIGS. 10A and 10B;

FIG. 12 is a schematic partially cross-sectional view of part of an image forming apparatus including the air intake structure according to the first exemplary embodiment;

FIG. 13 is a schematic partially cross-sectional view of part of an image forming apparatus having an air intake structure including a flow path formed from a combination of components in, for example, the second exemplary embodiment; and

FIG. 14 is a schematic diagram of an air intake structure according to a comparative example.

### DETAILED DESCRIPTION

Exemplary embodiments of the present disclosure are described below.

### First Exemplary Embodiment

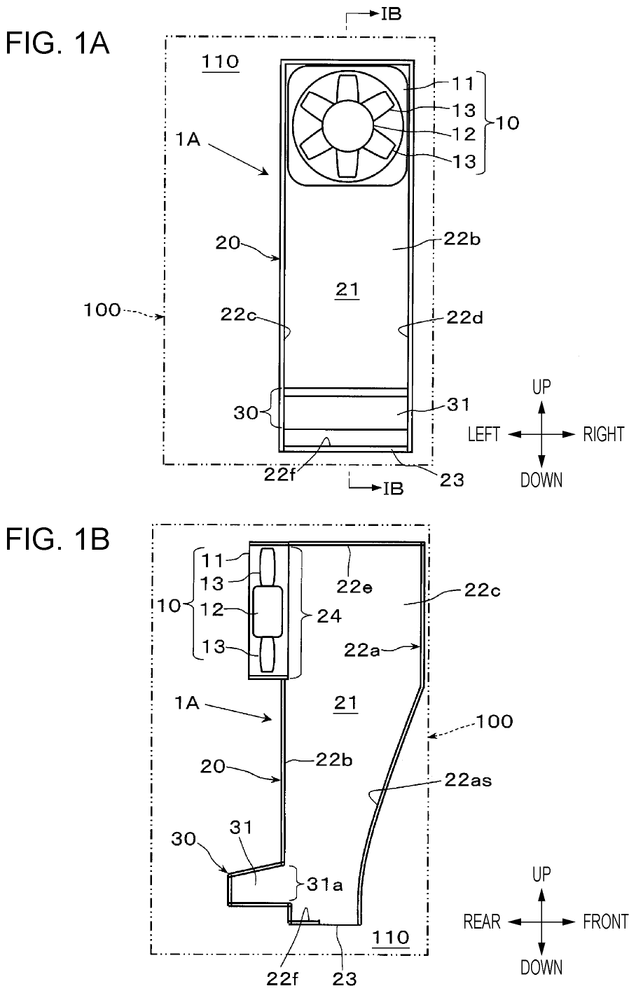

FIGS. 1A and 1B are schematic diagrams of an air intake structure 1A according to a first exemplary embodiment of the present disclosure.

Herein and throughout the drawings, substantially the same components are denoted with the same reference signs, and are not described redundantly.

### Components of Air Intake Structure

As illustrated in FIGS. 1A and 1B, the air intake structure 1A includes a blower 10, and a flow path 20 including an inlet port 23 that draws in air and a flow path space 21 connected to the inlet port 23 to allow air drawn in through the inlet port 23 to flow to the blower 10.

FIGS. 1A and 1B illustrate an application device 100 indicated with a two-dot chain line and including the air intake structure 1A. The application device 100 has an interior space 110.

The blower 10 is a device that draws in and directs air to a destination.

The blower 10 according to the first exemplary embodiment includes a frame 11 having an interior space that extends through the inside, a rotation shaft 12 disposed in the interior space of the frame 11 and including a built-in motor, and air-blowing blades 13 attached to the outer circumference of the rotation shaft 12.

Although an axial fan is used as the blower 10, the blower 10 is not limited to a particular one, and may be of another type such as a centrifugal fan.

The blower 10 is connected to, for example, a power supply or a controller not illustrated. The blower 10 is driven to rotate in a predetermined direction at the operation timing.

The flow path 20 is a structural component having the flow path space 21 in which air drawn in through the inlet port 23 is guided and directed to the blower 10.

The flow path 20 according to the first exemplary embodiment entirely has a shape of an angular pipe extending vertically. The angular pipe shape is, or similar to, a shape of a pipe with a polygonal cross-sectional interior shape, such as a quadrangular cross-sectional interior shape.

More specifically, the flow path 20 is a structural component including a front inner wall portion 22a, a rear inner wall portion 22b, a left inner wall portion 22c, a right inner wall portion 22d, an upper-end inner wall portion 22e, and a lower-end inner wall portion 22f. The flow path space 21 is a space defined by the inner wall surfaces of these six inner wall portions.

Among the six inner wall portions defining the flow path 20, except for the front inner wall portion 22a, the entire inner wall surfaces of the rear inner wall portion 22b, the left inner wall portion 22c, the right inner wall portion 22d, the upper-end inner wall portion 22e, and the lower-end inner wall portion 22f are substantially planar.

The inner wall surface of the front inner wall portion 22a at an upper portion is substantially planar, and the inner wall surface at the rest of the portion is an inclined curved surface, described below. The outer surfaces of the six inner wall portions 22a to 22f defining the flow path 20 opposite to the inner wall surfaces do not have to be planar surfaces, and may be other surfaces.

The inlet port 23 has a rectangular opening at a position located at a front portion of the lower-end inner wall portion 22f. Thus, the inlet port 23 is located below the blower 10.

The inlet port 23 is normally provided to draw in air outside the application device 100 including the air intake structure 1A, for the purposes such as cooling.

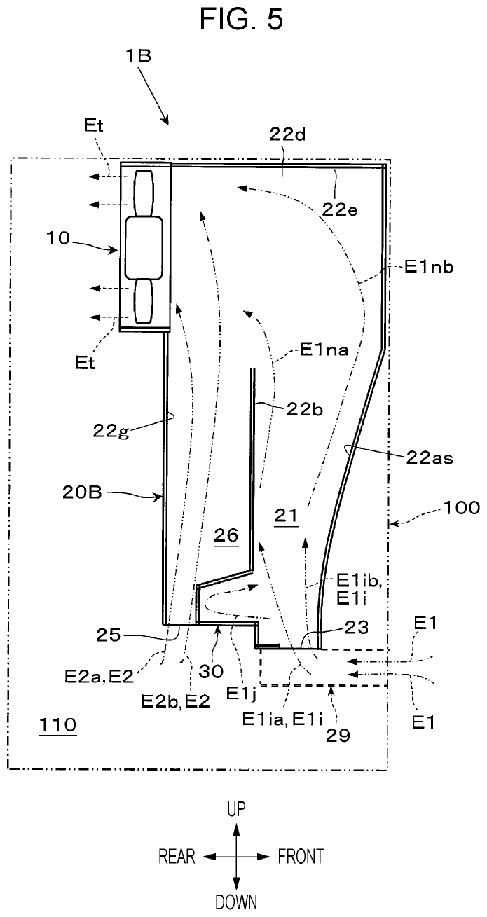

Instead, the inlet port 23 may be designed to draw in air at a desired portion corresponding to, for example, the purpose of use. Alternatively, as appropriate, a junction connection member 29 (refer to FIG. 5) formed from, for example, a pipe connected to draw in air outside the application device 100 may be used as the inlet port 23.

The flow path 20 has, at an upper portion of the rear inner wall portion 22b, a substantially quadrangular outlet port 24 that is open to be continuous with the upper-end inner wall portion 22e.

The blower 10 is attached to the outlet port 24 by being fitted into it. Thus, the flow path 20 is connected to the blower 10 through the outlet port 24.

In the flow path 20, the cross-sectional area of the flow path space 21 gradually expands from the inlet port 23 to at least a portion in front of the blower 10. At this time, the cross-sectional area is the cross-sectional area of the flow path space 21 drawn in the direction crossing (substantially perpendicular to) the direction in which air flows.

In the first exemplary embodiment, a lower portion of the inner wall surface of the front inner wall portion 22a below the blower 10 serves as an inclined curved surface 22as, which is a curved surface extending from the lower end at the inlet port 23 to the upper end near the blower 10 and gradually inclined from the rear to the front. Thus, the flow path space 21 has its cross-sectional area gradually increasing as it expands from the inlet port 23 toward the blower 10.

The entirety of the flow path 20 with this structure serves as an independent dedicated air-vent pipe (duct). Instead of the flow path 20 entirely serving as a dedicated pipe, the inner wall portion of the flow path 20 may be formed by being partially combined with another component such as a component in the application device 100 in the air intake structure 1A.

### Structure of Recessed Portion

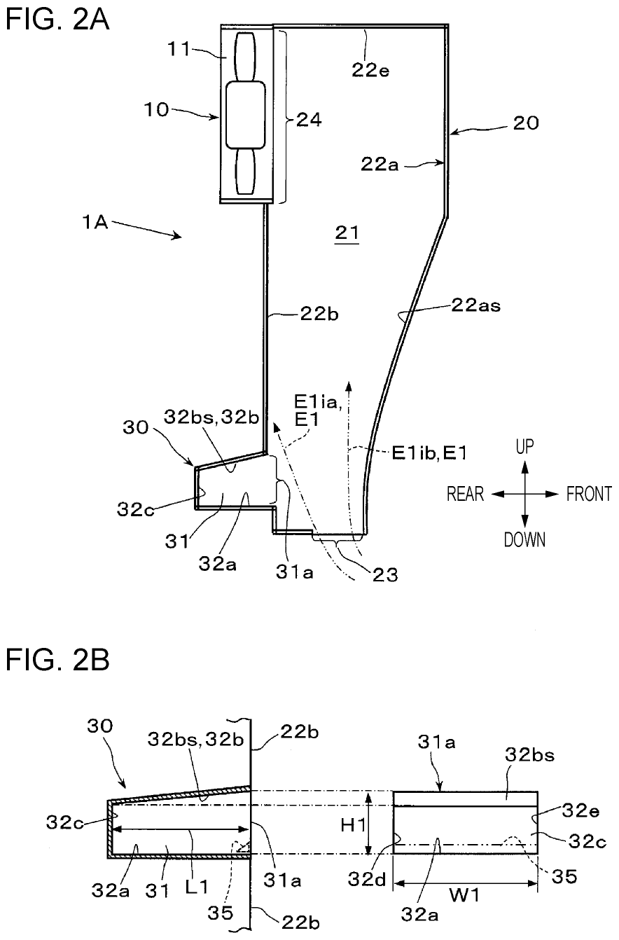

As illustrated in, for example, FIGS. 1A, 1B, 2A, and 2B, the air intake structure 1A includes a recessed portion 30 having a recessed space 31 at a portion of the flow path 20 adjacent to the inlet port 23.

The recessed portion 30 is a structural component that protrudes to the outside of the flow path space 21 in the flow path 20 by a predetermined dimension, and that has the recessed space 31 inside, that opens to the flow path space 21. The recessed space 31 in FIGS. 1A, 1B, 2A, and 2B has an opening 31a.

In other words, the recessed space 31 in the recessed portion 30 is a space recessed from the flow path space 21 in a bag shape.

When the flow path length of the flow path space 21 from the inlet port 23 to a position in front of the blower 10 is divided into four sections, the position near the inlet port 23 is located in, for example, the section closest to the inlet port 23.

The recessed portion 30 according to the first exemplary embodiment is a structural component including a lower-end inner wall portion 32a, an upper-end inner wall portion 32b, a back inner wall portion 32c, a left inner wall portion 32d, and a right inner wall portion 32e. The recessed space 31 is a space defined by these five inner wall portions 32a to 32e.

The recessed portion 30 is located in the inner wall surface forming the flow path 20 at a portion against which air drawn in through the inlet port 23 hits first.

In the first exemplary embodiment, the inlet port 23 is located at a front portion of the lower-end inner wall portion 22f in the flow path 20. Thus, as indicated with an arrowed two-dot chain line in FIG. 2A, part Elia of the air E1 drawn in through the inlet port 23 flows to hit first against the inner wall surface of the rear inner wall portion 22b. Thus, the recessed portion 30 in the first exemplary embodiment is located on the inner wall surface of the rear inner wall portion 22b.

As illustrated in FIG. 2A, part E lib of the air E1 drawn in through the inlet port 23 flows toward the outlet port 24 without hitting against the inner wall surface of the rear inner wall portion 22b.

As illustrated in FIG. 2B, the recessed portion 30 has a relationship where a depth (length of the recess) L1 of the recessed space 31 is larger than a height H1 of the opening 31a in the recessed space 31 (L1>H1). The recessed portion 30 has a relationship where the depth L1 of the recessed space 31 is shorter than a width W1 of the opening 31a in the recessed space 31 (L1<W1).

As illustrated in FIGS. 2A and 2B, the recessed portion 30 has a slope 32bs, which is a portion of the inner wall surface of the inner wall portion defining the recessed space 31 located on the side closer to the blower 10 and inclined toward the blower 10 as it extends toward the opening 31a in the recessed space 31.

In the first exemplary embodiment, the inner wall surface of the upper-end inner wall portion 32b serves as the slope 32bs inclined obliquely upward as it extends toward the opening 31a from the back inner wall portion 32c. Thus, the recessed space 31 has its height gradually increasing from the inner wall surface of the back inner wall portion 32c toward the opening 31a.

The air intake structure 1A is used to draw air into the flow path and direct the air to a desired destination with the blower 10.

For example, the air intake structure 1A is disposed at a predetermined position in the interior space 110 in the application device 100 as indicated with a two-dot chain line in FIGS. 1A and 1B, and used to direct air outside the application device 100 into the interior space 110 in the application device 100.

Instead of being located in the interior space 110 of the application device 100, the air intake structure 1A may be disposed outside the application device 100.

### Operations of Air Intake Structure

In the air intake structure 1A with the above structure, the blower 10 starts being driven to rotate at the operation timing.

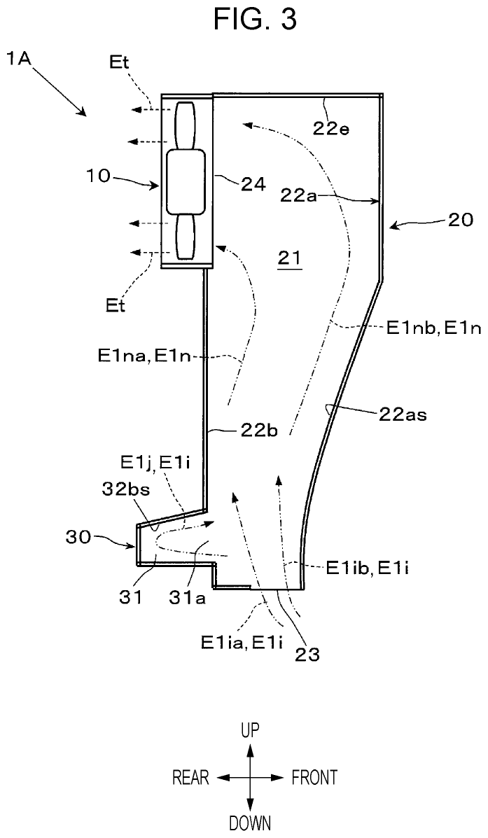

Thus, in the air intake structure 1A, the blower 10 causes a suction force, and the flow path space 21 in the flow path 20 has a negative pressure. As illustrated in FIG. 3, the air E1 outside the air intake structure 1A is drawn into the flow path space 21 through the inlet port 23 to serve as suction air E1i.

As illustrated in FIG. 2A, the part Elia of the suction air E1i obliquely flows from the inlet port 23 toward the rear inner wall portion 22b of the flow path space 21 to first hit against the rear inner wall portion 22b. As illustrated in FIG. 3, the part E1ib of the suction air E1i flows through the flow path space 21 toward the blower 10 without hitting against the rear inner wall portion 22b.

Subsequently, the suction air E1i flows through the flow path space 21 to the outlet port 24 where the blower 10 is disposed to serve as passing air E1n.

As illustrated in FIG. 3, part E1na of the passing air E1n hits against and passes by the rear inner wall portion 22b of the flow path space 21, or approaches and passes by the rear inner wall portion 22b, and then flows to be drawn into the blower 10. As illustrated in FIG. 3, part E1nb of the passing air E1n passes at a distance from the rear inner wall portion 22b, and then flows to be drawn into the blower 10.

Finally, as illustrated in FIG. 3, the passing air E1n is drawn into the blower 10, and directed to a predetermined destination from the blower 10 as efflux air Et.

FIGS. 1A and 1B illustrate an example purpose of use where efflux air Et is directed to the interior space 110 in the application device 100.

In the air intake structure 1A, the suction air E1i drawn into the flow path space 21 through the inlet port 23 of the flow path 20 usually contains at least one of water vapor and dust.

In this case, in the air intake structure 1A, part Elia of the suction air E1i flows into the recessed space 31 from the opening 31a of the recessed portion 30 located adjacent to the inlet port 23 of the flow path space 21.

Inflow air E1j that has flowed into the recessed space 31 temporarily stays in the recessed space 31, and is then discharged into the flow path space 21 from the opening 31a to flow again toward the blower 10.

Specifically, after the inflow air E1j at this time hits against the inner wall surface of the back inner wall portion 32c in the recessed space 31 to temporarily stay in a turbulent flow, the inflow air E1j receives an effect of an air flow in the flow path space 21 to change its direction inside the recessed space 31 to be drawn into the flow path space 21 from the opening 31a.

At this time, when the inflow air E1j contains a relatively large amount of water vapor, and when the inflow air E1j hits against the inner wall surface of the back inner wall portion 32c in the recessed space 31 to stay temporarily, the water vapor comes into contact with the inner wall surfaces of the inner wall portions 32a to 32e defining the recessed space 31. When exceeding a saturated water-vapor density, the water vapor condenses to form waterdrops, and may be held and trapped in the recessed space 31.

At this time, when the inflow air E1j contains a relatively large amount of dust, when the inflow air E1j temporarily stays in the recessed space 31, the dust comes into contact with the inner wall surfaces of the inner wall portions 32a to 32e defining the recessed space 31 to receive impacts, and may deviate from the flow of the inflow air E1j to be left and trapped in the recessed space 31.

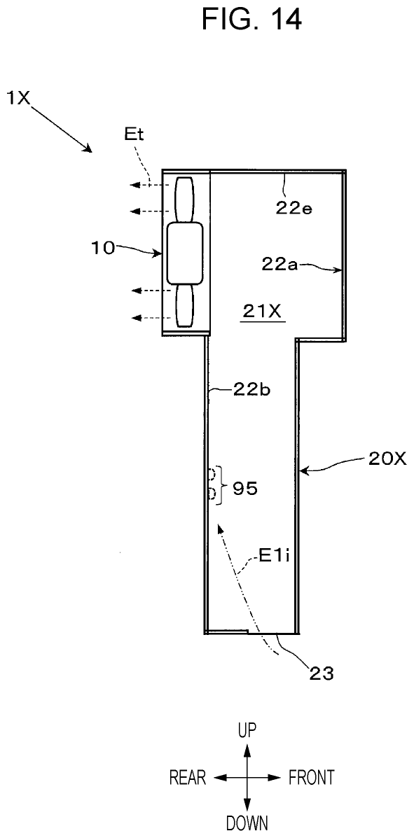

Thus, compared to an air intake structure 1X (FIG. 14) according to a comparative example not including the recessed portion 30 at a predetermined position in a flow path 20X, the air intake structure 1A reduces transportation, through the blower 10, of at least one of water vapor and dust contained in the air (suction air E1i) drawn in through the inlet port 23 of the flow path 20.

When the blower 10 is driven to rotate, as illustrated in FIG. 14, the air intake structure 1X according to the comparative example draws air E1 through the inlet port 23 in the flow path 20X not including the recessed portion 30 into a flow path space 21X as suction air E1i.

In the air intake structure 1X, when part of the suction air E1i that flows to first hit against the inner wall surface of the rear inner wall portion 22b contains water vapor, part of the water vapor may condense at the inner wall surface of the rear inner wall portion 22b to form waterdrops 95. When the waterdrops 95 accumulate and increase, the waterdrops 95 drip in the flow path space 21X, and may leak outside the air intake structure 1X through the inlet port 23.

When the suction air E1i contains dust, the dust that has flowed through the flow path space 21X may be directly discharged to the outside of the air intake structure 1X by the blower 10.

In contrast, the air intake structure 1A including the recessed portion 30 reduces a discharge of at least one of water vapor and dust contained in the suction air E1i through the blower 10. The air intake structure 1A thus reduces dripping or leakage of the waterdrops that may occur in the air intake structure 1X according to the comparative example and a discharge of the dust to the outside of the air intake structure 1X.

The air intake structure 1A may exclude a filter that traps dust. Instead, the air intake structure 1A may include a filter at part of the flow path 20 as needed.

In the air intake structure 1A, the cross-sectional area of the flow path space 21 in the flow path 20 gradually increases from the inlet port 23 to at least a position in front of the blower 10.

Thus, in the air intake structure 1A, the speed of the suction air E1i near the inlet port 23 where the flow path space 21 has a narrowest cross-sectional area is the maximum, higher than the speed of the passing air E1n at a position in front of the blower 10 where the flow path space 21 has a widest cross-sectional area. Thus, part Elia of the suction air E1i that flows to first hit against the inner wall surface of the rear inner wall portion 22b is more likely to be directed into the recessed space 31 in the recessed portion 30 located adjacent to the inlet port 23.

Thus, compared to the case where the cross-sectional area of the flow path space 21 in the flow path 20 is the same throughout or decreases from the inlet port 23 to at least the position in front of the blower 10, the air intake structure 1A further reduces transportation, through the blower 10, of at least one of water vapor and dust contained in the air drawn in through the inlet port 23.

In the air intake structure 1A, the recessed portion 30 is located in the inner wall surface of the rear inner wall portion 22b against which air drawn into the flow path space 21 through the inlet port 23 hits first.

Compared to the structure where the recessed portion 30 is located in an inner wall surface other than the inner wall surface against which drawn air hits first, the air intake structure 1A is more likely to allow air drawn in through the inlet port 23 to enter the recessed space 31 in the recessed portion 30, and reduce transportation, through the blower 10, of at least one of water vapor and dust contained in air passing through the flow path space 21.

The air intake structure 1A has a relationship where the depth L1 of the recessed space 31 is larger than the height H1 of the opening 31a in the recessed space 31.

Compared to the structure where the depth L1 of the recessed space 31 is the same as or shorter than the height H1 of the opening 31a in the recessed space 31, the air intake structure 1A more easily allows air that has entered the recessed space 31 to stay therein, and traps at least one of water vapor and dust contained in the air drawn in through the inlet port 23 in the recessed space 31.

In the air intake structure 1A, among the inner wall surfaces of the inner wall portions defining the recessed space 31, the inner wall surface of the upper-end inner wall portion 32b located closer to the blower 10 serves as the slope 32bs that is inclined toward the blower 10 as it extends toward the opening 31a in the recessed space 31.

Thus, compared to the structure where the inner wall surface of the upper-end inner wall portion 32b defining the recessed space 31 is not a slope, the air intake structure 1A traps, in the recessed space 31, the waterdrops caused by condensation of water vapor in the air on the inner wall surface of the rear inner wall portion 22b in the flow path space located at an upper portion of the recessed portion 30 by causing the waterdrops to trickle down the slope 32bs. Thus, the air intake structure 1A reduces waterdrops that pass through the recessed portion 30 and drip below the recessed portion 30.

### Modification Example of First Exemplary Embodiment

As indicated with a broken line in FIG. 2B, the air intake structure 1A may include a protrusion 35 at the bottom portion of the recessed space 31 in the recessed portion 30 adjacent to the opening 31a. The protrusion 35 reduces dripping of waterdrops that form through condensation of water vapor.

In this case, the bottom portion near the opening 31a serves as the end portion of the lower-end inner wall portion 32a defining part of the recessed space 31 adjacent to the opening 31a.

The protrusion 35 extends throughout in the width direction of the opening 31a parallel to the lateral direction. The protrusion 35 may have any height or form that does not block air flowing into the recessed space 31 and that reduces waterdrops flowing out from the recessed space 31.

Compared to a structure not including the protrusion 35, the air intake structure 1A including the protrusion 35 reduces leakage of waterdrops caused by condensation of water vapor trapped in the recessed space 31, out of the recessed space 31.

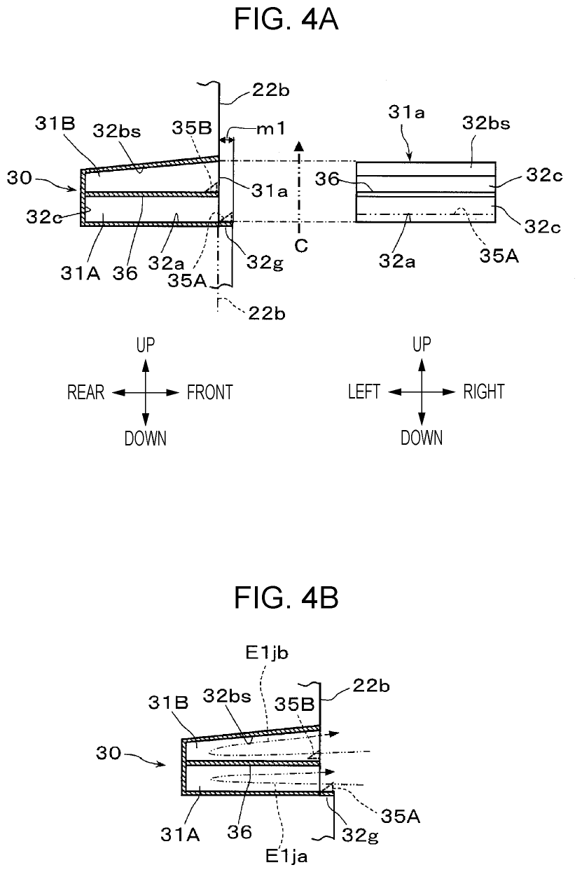

As illustrated in FIG. 4A, the air intake structure 1A may include, in the recessed space 31 in the recessed portion 30, a plate 36 that extends in a direction crossing a direction C in which the air drawn in through the inlet port 23 flows.

In this case, an example used as the plate 36 is a substantially flat plate that extends in the direction substantially perpendicular to the direction C in which air flows and that is substantially planar in the lateral direction and the front-rear direction.

The plate 36 extends from the opening 31a in the recessed space 31 to reach and come into contact with the inner wall surface of the back inner wall portion 32c. Thus, the plate 36 divides the recessed space 31 in the vertical direction into two recessed spaces 31A and 31B.

Compared to the structure not including the plate 36, in the air intake structure 1A including the plate 36 as illustrated in FIG. 4B, air E1ja or E1jb that enters the corresponding one of the recessed spaces 31A and 31B in the recessed portion 30 occurs, and the air intake structure 1A increases the locations in the two recessed spaces 31A and 31B where water vapor or dust is trapped. Thus, the air intake structure 1A reduces transportation, through the blower 10, of water vapor and dust contained in air drawn in through the inlet port 23.

As illustrated in FIG. 4A, in the air intake structure 1A, the lower-end inner wall portion 32a defining part of the recessed space 31 in the recessed portion 30 may receive a protruding inner wall portion 32g that protrudes by a predetermined dimension m1 into the flow path space 21 beyond the rear inner wall portion 22b of the flow path space 21.

At this time, the protruding inner wall portion 32g may be regarded as a portion obtained by protruding a lower portion of the rear inner wall portion 22b defining part of the flow path space 21 below an opening 31a of the recessed portion 30 by a predetermined dimension m1 from the inner wall surface of the rear inner wall portion 22b located above the opening 31a of the recessed portion 30.

Compared to a structure not including the protruding inner wall portion 32g, the air intake structure 1A including the protruding inner wall portion 32g receives and traps, with the protruding inner wall portion 32g, waterdrops caused by condensation of water vapor dripping down from, for example, the inner wall surface of the rear inner wall portion 22b located above the opening 31a of the recessed portion 30.

When including the protruding inner wall portion 32g or the plate 36, the air intake structure 1A may include protrusions 35A and 35B that block dripping of waterdrops at an end portion of the protruding inner wall portion 32g and an end portion of the plate 36 near the opening 31a, as indicated with broken lines in FIG. 4A.

Compared to the structure not including the protrusions 35A and 35B, the air intake structure 1A including the protrusions 35A and 35B further reduces leakage of waterdrops caused by condensation of water vapor trapped in the two recessed spaces 31A and 31B, out of the recessed spaces 31A and 31B.

### Second Exemplary Embodiment

FIG. 5 schematically illustrates an air intake structure 1B according to a second exemplary embodiment of the present disclosure.

The air intake structure 1B has the same structure as the air intake structure 1A according to the first exemplary embodiment except for addition of a flow path 20B including a second inlet port 25 and a second flow path space 26.

The flow path 20B has the same structure as the flow path 20 in the first exemplary embodiment except that it additionally includes the second inlet port 25 and the second flow path space.

The second inlet port 25 is different from the inlet port 23 of the flow path space 21, and disposed at a position different from that of the inlet port 23 of the flow path 20. The second inlet port 25 may be provided to, for example, draw air in the interior space 110 in the application device 100 including the air intake structure 1B.

As illustrated in FIG. 5, the second exemplary embodiment includes the second inlet port 25 located adjacent to the recessed portion 30. The second inlet port 25 draws air E2 in the interior space 110 in the application device 100.

The second flow path space 26 allows the air E2 drawn in through the second inlet port 25 to flow therethrough to merge with the air E1 drawn in through the inlet port 23 at a position in the flow path 20 in front of the blower 10.

As illustrated in FIG. 5, the second flow path space 26 in the second exemplary embodiment is defined with the rear inner wall portion 22b in the flow path space 21 having an upper end located lower than that of the rear inner wall portion 22b in the first exemplary embodiment, and a new rearmost inner wall portion 22g at the rear of the rear inner wall portion 22b. The rearmost inner wall portion 22g extends substantially straight and upward from the second inlet port 25 to the lower end of the blower 10 at a position a predetermined distance apart and rear of the rear inner wall portion 22b. The inner wall surface of the rearmost inner wall portion 22g is formed from a substantially flat plate.

The second flow path space 26 is a space defined by the rear inner wall portion 22b, the rearmost inner wall portion 22g, the left inner wall portion 22c (refer to FIG. 1A), and the right inner wall portion 22d, and merges with the flow path space 21 at the upper end of the rear inner wall portion 22b.

As indicated with a two-dot chain line in FIG. 5, the air intake structure 1B is located at a predetermined portion in the interior space 110 in the application device 100.

In this case, as indicated with a chain line in FIG. 5, the junction connection member 29 such as a pipe connected to the opening of the application device 100 that opens outward may be connected to the inlet port 23 in the flow path 20B. Connection of the junction connection member 29 facilitates the external air E1 flowing obliquely (toward the inner wall surface of the rear inner wall portion 22b) from the inlet port 23 to the flow path space 21.

The second inlet port 25 of the flow path 20B draws the air E2 in the interior space 110 in the application device 100.

### Operation of Air Intake Structure

When the blower 10 starts being driven to rotate at the operation timing, the air intake structure 1B operates in the following manner.

As illustrated in FIG. 5, the flow path 20B in the air intake structure 1B draws the external air E1 outside the application device 100 through the inlet port 23 through the junction connection member 29 into the flow path space 21 as the suction air E1i.

As described in the first exemplary embodiment, the part Elia of the suction air E1i flows through the flow path space 21 to hit against the inner wall surface of the rear inner wall portion 22b, and partially flows into the recessed space 31 in the recessed portion 30 and then returns again to the flow path space 21. The part Elia of the suction air flows through the flow path space 21 as the passing air E1na.

As described in the first exemplary embodiment, the part E1ib of the suction air E1i flows through the flow path space 21 without hitting against the inner wall surface of the rear inner wall portion 22b, and then flows through the flow path space 21 along the inner wall surface of the front inner wall portion 22a as the passing air E1nb.

As illustrated in FIG. 5, the flow path 20B draws the air E2 in the interior space 110 in the application device 100 through the second inlet port 25 into the second flow path space 26. This drawn air E2 flows through the second flow path space 26 toward the blower 10 as indicated with arrowed two-dot chain lines E2a and E2b in FIG. 5.

Subsequently, in the flow path 20B, the air E1 (passing air E1na and E1nb) that has flowed through the flow path space 21 and the air E2 (air E2a and E2b) that has flowed through the second flow path space 26 merge with each other at a position in front of the blower 10.

At this time, the air E2 (air E2a and E2b) flows through the flow path 20B while temporarily pushing the air E1 (passing air E1na and E1nb) against the inner wall surface of the upper-end inner wall portion 22e.

Thus, compared to a structure where the flow path 20B includes neither the second inlet port 25 nor the second flow path space 26, the air intake structure 1B further reduces the amount of at least dust contained in the air E1 drawn in through the inlet port 23 arriving at the blower 10 as a result of the merging when the air E2 drawn through the second inlet port 25 contains a small amount of dust.

### Third Exemplary Embodiment

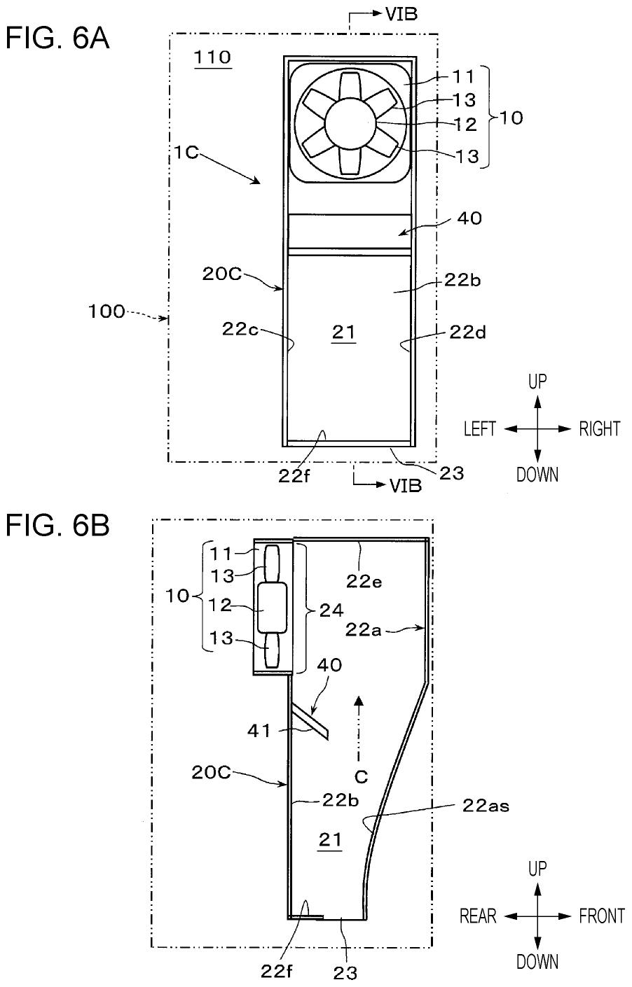

FIGS. 6A and 6B schematically illustrate an air intake structure 1C according to a third exemplary embodiment of the present disclosure.

The air intake structure 1C has the same structure as the air intake structure 1A according to the first exemplary embodiment except that it includes a protrusion 40 instead of the recessed portion 30 in the flow path 20.

As illustrated in FIGS. 6A and 6B and other drawings, the air intake structure 1C includes the protrusion 40 disposed on the rear inner wall portion 22b and at a portion of the flow path 20 in front of the blower 10. The protrusion 40 has a slope 41. The flow path 20 in the third exemplary embodiment has the same structure as the flow path 20 in the first exemplary embodiment except that it does not include the recessed portion 30.

### Structure of Protrusion

The protrusion 40 is preferably located at a portion of the flow path 20 closer to the blower 10 than to the inlet port 23.

A portion 42 of the protrusion 40 according to the third exemplary embodiment opposite to the slope 41 is a flat surface substantially parallel to the slope 41, and is entirely formed from a planar plate member.

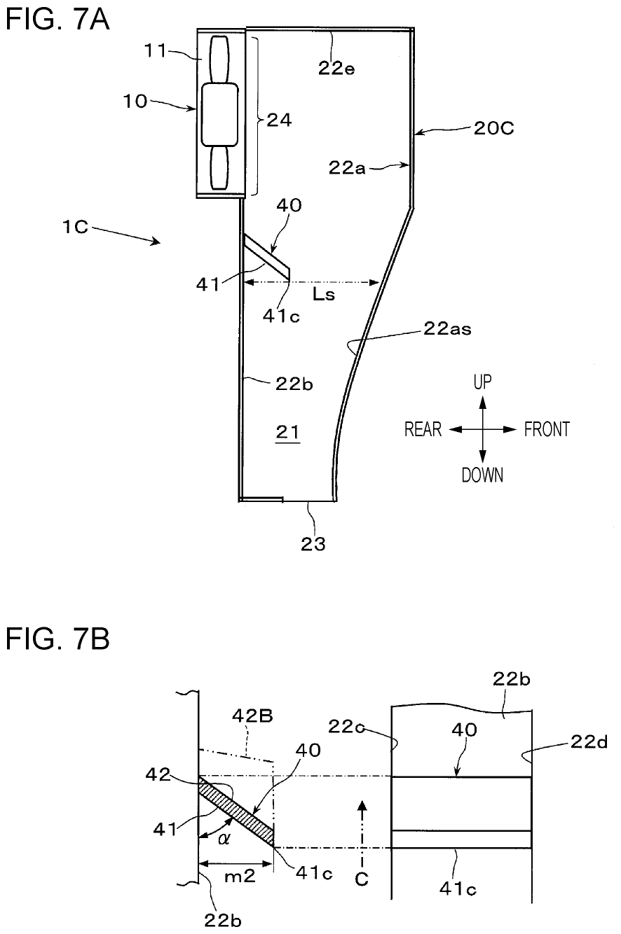

As long as the protrusion 40 includes the slope 41, the portion 42 opposite to the slope 41 may have any shape. As indicated with a two-dot chain line in FIG. 7B, the portion 42 of the protrusion 40 opposite to the slope 41 may be formed from a surface other than a flat surface substantially parallel to the slope 41.

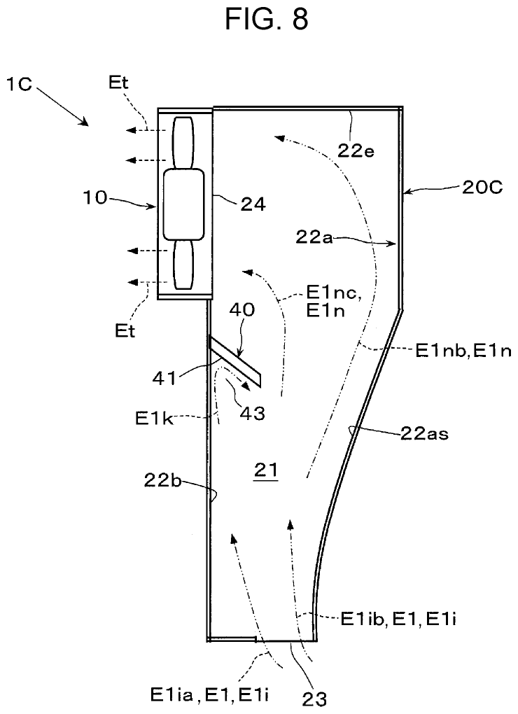

The slope 41 of the protrusion 40 is inclined upstream in the direction C in which the drawn air E1 flows. An angle α (refer to FIG. 7B) that the slope 41 forms with the inner wall surface of the rear inner wall portion 22b may be any angle that allows part of air flowing through the flow path space 21 to flow into a dead-end space 43 (refer to FIG. 8) defined by, for example, the inner wall surface of the rear inner wall portion 22b and to stay temporarily. The dead-end space 43 will be described later. The angle α is preferably smaller than 90 degrees.

An amount (dimension) m2 (refer to FIG. 7B) by which an inclined far end 41c of the slope 41 protrudes from the inner wall surface of the rear inner wall portion 22b is set to, for example, the following dimension. As illustrated in FIG. 7A, the protruding amount m2 is set to be smaller than a distance Ls, which is a distance in the flow path space 21 between the inner wall surface of the front inner wall portion 22a and the inner wall surface of the rear inner wall portion 22b at a portion passing the far end 41c of the slope 41.

### Operation of Air Intake Structure

The air intake structure 1C operates in the following manner when the blower 10 starts being driven to rotate at the time of operation.

As in the case of the air intake structure 1A according to the first exemplary embodiment, as illustrated in FIG. 8, the flow path 20 in the air intake structure 1C draws the air E1 outside the air intake structure 1C through the inlet port 23 into the flow path space 21 as the suction air E1i.

Subsequently, as in the case of the air intake structure 1A according to the first exemplary embodiment, the suction air E1i flows through the flow path space 21 to reach the outlet port 24 where the blower 10 is disposed as the passing air E1n. Passing air E1nc in the passing air E1n that passes by the protrusion 40 detours around the protrusion 40. At the same time, influx air Elk described later flows to return, and the passing air E1nc flows slightly differently from the passing air E1na according to the first exemplary embodiment.

Finally, as illustrated in FIG. 8, after being drawn into the blower 10, the passing air E1n is directed from the blower 10 toward a predetermined destination as efflux air Et.

As described in the first exemplary embodiment, in the air intake structure 1C, the part Elia of the suction air E1i flows through the flow path space 21 to hit against the inner wall surface of the rear inner wall portion 22b, and partially flows into the dead-end space 43 defined by the inner wall surface of the rear inner wall portion 22b, the slope 41 of the protrusion 40, and the inner wall surfaces of the left inner wall portion 22c and the right inner wall portion 22d.

The influx air E1k that has flowed into the dead-end space 43 temporarily stays in the dead-end space 43 in a turbulent flow, and then flows back into the flow path space 21 from the far end 41c of the slope 41.

At this time, when the inflow air E1k contains a relatively large amount of dust, and when the inflow air E1k temporarily stays inside the dead-end space 43 in the protrusion 40, the dust irregularly comes into contact with the slope 41 of the protrusion 40 and the inner wall surface of the rear inner wall portion 22b defining the dead-end space 43 to receive impacts, and deviates from the flow of the influx air E1k to be left and trapped in the dead-end space 43.

At this time, when the inflow air E1k contains a relatively large amount of water vapor, and when the inflow air E1k temporarily stays in the dead-end space 43, the water vapor comes into contact with, for example, the slope 41 of the protrusion 40 or the inner wall surface of the rear inner wall portion 22b defining the dead-end space 43. When exceeding a saturated water-vapor density, the water vapor condenses to form waterdrops, and may be held and trapped in the dead-end space 43.

Thus, compared to the air intake structure 1X (FIG. 14) according to a comparative example not including the protrusion 40 at a predetermined position in the flow path 20X, the air intake structure 1C reduces transportation, through the blower 10, of at least one of water vapor and dust contained in the air (suction air E1i) drawn in through the inlet port 23 of the flow path 20.

The air intake structure 1C including the protrusion 40 reduces transportation, through the blower 10, of at least one of water vapor and dust contained in the suction air E1i, and thus reduces dripping or leakage of the waterdrops that may occur in the air intake structure 1X according to the comparative example and a discharge of the dust to the outside of the air intake structure 1X.

As in the flow path 20 in the air intake structure 1A according to the first exemplary embodiment, in the air intake structure 1C, the cross-sectional area of the flow path space 21 in the flow path 20 gradually increases from the inlet port 23 to at least a position in front of the blower 10.

Thus, as in the flow path 20 in the first exemplary embodiment, in the air intake structure 1C, the speed of the suction air E1i near the inlet port 23 where the flow path space 21 has a narrowest cross-sectional area is the maximum, higher than the speed of the passing air E1n at a position in front of the blower 10 where the flow path space 21 has a widest cross-sectional area. Thus, part Elia of the suction air E1i that flows to first hit against the inner wall surface of the rear inner wall portion 22b is more likely to be directed into the dead-end space 43 in the protrusion 40 located on the inner wall surface of the rear inner wall portion 22b.

Thus, compared to the case where the cross-sectional area of the flow path space 21 in the flow path 20 is the same throughout or decreases from the inlet port 23 to at least the position in front of the blower 10, the air intake structure 1C further reduces transportation, through the blower 10, of at least one of water vapor and dust contained in the air drawn in through the inlet port 23.

Also in the air intake structure 1C, the protrusion 40 is located on the inner wall surface of the rear inner wall portion 22b against which air drawn into the flow path space 21 through the inlet port 23 hits first.

Compared to the structure where the protrusion 40 is located on an inner wall surface other than the inner wall surface against which air drawn into the protrusion 40 hits first, the air intake structure 1C is more likely to allow air drawn in through the inlet port 23 to enter the dead-end space 43 in the protrusion 40, and reduce transportation, through the blower 10, of at least one of water vapor and dust contained in air passing through the flow path space 21.

### Fourth Exemplary Embodiment

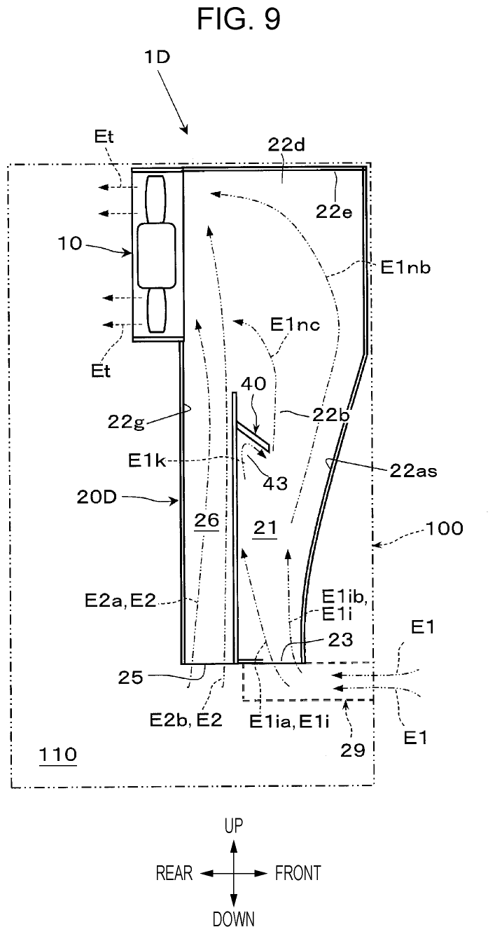

FIG. 9 schematically illustrates an air intake structure 1D according to a fourth exemplary embodiment of the present disclosure.

The air intake structure 1D has substantially the same structure as the air intake structure 1B according to the second exemplary embodiment and the air intake structure 1C according to the third exemplary embodiment, except that the air intake structure 1D includes a protrusion 40 instead of the recessed portion 30, and additionally includes a flow path 20D including the second inlet port 25 and the second flow path space 26.

The flow path 20D in the air intake structure 1D has the same structure as the flow path 20B in the second exemplary embodiment except that it includes the protrusion 40 instead of the recessed portion 30.

The second inlet port 25 has the same structure as the second inlet port 25 in the second exemplary embodiment.

As illustrated in FIG. 9, in the fourth exemplary embodiment, the second inlet port 25 is located in the flow path space 21 at a position adjacent to the inlet port 23. The second inlet port 25 draws the air E2 in the interior space 110 in the application device 100.

The second flow path space 26 has the same structure as the second flow path space 26 in the second exemplary embodiment.

As illustrated in FIG. 9, as in the case of the rear inner wall portion 22b in the second exemplary embodiment, the second flow path space 26 in the fourth exemplary embodiment is defined with the rear inner wall portion 22b in the flow path space 21 having an upper end located lower, and a new rearmost inner wall portion 22g at the rear of the rear inner wall portion 22b. The rearmost inner wall portion 22g has the same structure as the rearmost inner wall portion 22g in the second exemplary embodiment.

As in the air intake structure 1B according to the second exemplary embodiment, the air intake structure 1D is located at a predetermined portion in the interior space 110 in the application device 100 as indicated with a two-dot chain line in FIG. 9.

Also in this case, the junction connection member 29 such as a pipe may be connected to the inlet port 23 in the flow path 20D. Connection of the junction connection member 29 facilitates the external air E1 flowing obliquely (toward the inner wall surface of the rear inner wall portion 22b) from the inlet port 23 to the flow path space 21.

The second inlet port 25 of the flow path 20D draws the air E2 in the interior space 110 in the application device 100.

### Operation of Air Intake Structure

When the blower 10 starts being driven to rotate at the operation timing, the air intake structure 1D operates in the following manner.

As illustrated in FIG. 9, the flow path 20D in the air intake structure 1D draws the external air E1 outside the application device 100 through the inlet port 23 through the junction connection member 29 into the flow path space 21 as the suction air E1i.

As described in the first exemplary embodiment, the part Elia of the suction air E1i flows through the flow path space 21 to hit against the inner wall surface of the rear inner wall portion 22b, and partially flows into the dead-end space 43 in the protrusion 40 and then flows back again to the flow path space 21. The part Elia of the suction air flows through the flow path space 21 as the passing air E1nc.

As described in the first exemplary embodiment, the part E1ib of the suction air E1i flows through the flow path space 21 without hitting against the inner wall surface of the rear inner wall portion 22b, and then flows through the flow path space 21 along the inner wall surface of the front inner wall portion 22a as the passing air E1nb.

As illustrated in FIG. 9, the flow path 20D draws the air E2 in the interior space 110 in the application device 100 through the second inlet port 25 into the second flow path space 26. This drawn air E2 flows through the second flow path space 26 toward the blower 10 as indicated with arrowed two-dot chain lines E2a and E2b in FIG. 9.

Subsequently, in the flow path 20D, the air E1 (passing air E1nb and E1nc) that has flowed through the flow path space 21 and the air E2 (air E2a and E2b) that has flowed through the second flow path space 26 merge with each other at a position in front of the blower 10.

At this time, the air E2 (air E2a and E2b) flows through the flow path 20D while temporarily pushing the air E1 (passing air E1nb and E1nc) against the inner wall surface of the upper-end inner wall portion 22e.

Thus, compared to a structure where the flow path 20D includes neither the second inlet port 25 nor the second flow path space 26, the air intake structure 1D reduces, with the occurrence of the merging, the amount of at least dust contained in the air E1 drawn in through the inlet port 23 arriving at the blower 10 when the air E2 drawn through the second inlet port 25 contains a small amount of dust.

### Fifth Exemplary Embodiment

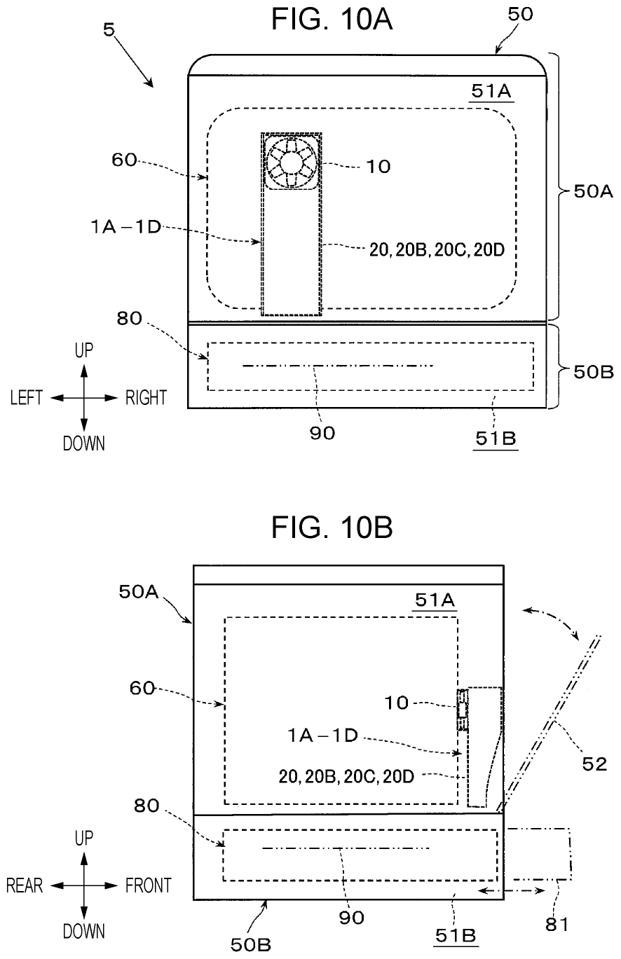

FIGS. 10A and 10B schematically illustrate an image forming apparatus 5 according to a fifth exemplary embodiment.

As illustrated in FIGS. 10A and 10B, the image forming apparatus 5 includes a housing 50 with a predetermined appearance. The housing 50 accommodates, in its interior space, components such as an image forming unit 60, a medium provider 80, and a power supply and a controller not illustrated.

The housing 50 is a structural component having a predetermined structure and a predetermined shape with a combination of, for example, various support members and exterior members.

The housing 50 in the fifth exemplary embodiment includes the image forming unit 60, an upper housing 50A that accommodates components such as a controller and a power supply not illustrated, and a lower housing 50B that accommodates the medium provider 80. The upper housing 50A and the lower housing 50B may be formed from portions of one housing 50 vertically divided by a partitioning plate.

As illustrated in FIG. 10B, the housing 50 according to the fifth exemplary embodiment includes an openable covering 52 on the front side of the upper housing 50A. The openable covering 52 is openable through operation. The openable covering 52 is opened to fall frontward around a support shaft not illustrated at the lower end.

The image forming unit 60 forms an image with a developer, and transfers the image to a recording medium 90.

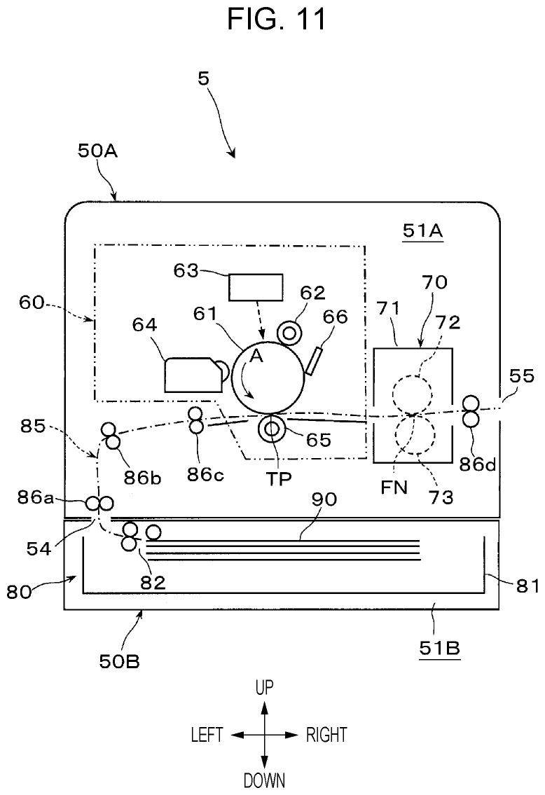

As illustrated in FIG. 11, the image forming unit 60 according to the fifth exemplary embodiment includes a photoconductor drum 61 that is driven to rotate in an arrow direction. The image forming unit 60 also includes devices such as a charging device 62, a latent-image forming device 63, a developing device 64, a transfer device 65, and a drum cleaning device 66 arranged around the photoconductor drum 61. The image forming unit 60 is accommodated in an interior space 51A in the upper housing 50A.

The latent-image forming device 63 exposes the charged photoconductor drum 61 to light based on image information input from a connected device such as an information terminal or a document reading device to which the image forming apparatus 5 is connected to form an electrostatic latent image on the photoconductor drum 61. The developing device 64 accommodates a developer (toner) of a predetermined color, and develops an electrostatic latent image to form a toner image.

The medium provider 80 is a component that accommodates and feeds recording media 90 to be fed to a position where the image forming unit 60 performs transfer.

The position where the image forming unit 60 performs transfer is a transfer position TP, located between the photoconductor drum 61 and the transfer device 65 in the fifth exemplary embodiment.

As illustrated in FIG. 11, the medium provider 80 in the fifth exemplary embodiment includes components such as a container 81 that accommodates a stack of multiple recording media 90 in a predetermined orientation, and a pick-up device 82 that picks up the recording media 90 accommodated in the container 81 one by one. The medium provider 80 is accommodated in an interior space 51B in the lower housing 50B.

The container 81 is attached while being drawable frontward to the outside from the interior space 51B in the lower housing 50B (refer to FIG. 11B) to enable, for example, replenishment of the recording media 90. Sheet media such as recording sheets are used as an example of the recording media 90.

A medium transport path 85 for transporting the recording media 90 is disposed between the lower housing 50B and the upper housing 50A.

The medium transport path 85 includes components or devices such as multiple transport rollers 86a to 86d that transport the recording media 90 while holding the recording media 90, and multiple guide members, not illustrated, that securely hold the transport space for the recording media 90 to guide the recording media 90 during transportation.

Between the upper housing 50A and the lower housing 50B, a passage port 54 is disposed to allow the transported recording media 90 to pass therethrough. The upper housing 50A has a discharge port 55 through which the recording medium 90 on which an image is formed is discharged to the outside.

A fixing unit 70 that fixes a toner image transferred to the recording medium 90 by the image forming unit 60 to the recording medium 90 is disposed.

As illustrated in FIG. 11, the fixing unit 70 according to the fifth exemplary embodiment is a fixing device including devices such as a heating rotor 72 and a pressing rotor 73 accommodated in the interior space of a housing 71 having an introduction port and a discharge port for the recording media 90.

A portion in the fixing unit 70 where the heating rotor 72 and the pressing rotor 73 are in contact serves as a fixing processing portion (nip) FN that performs, for example, heating and pressing to allow the recording medium 90 to which an unfixed toner image has been transferred to pass therethrough while holding the recording medium 90 therebetween and to fix the toner image to the recording medium 90 while the recording medium 90 passes therethrough.

The image forming apparatus 5 performs image formation in the following manner.

When a controller, not illustrated, in the image forming apparatus 5 receives a command of an image forming operation, the photoconductor drum 61 is driven to rotate and the image forming unit 60 performs operations such as a charging operation, an exposure operation, a development operation, a transfer operation, and a cleaning operation. At the same time, the medium provider 80 performs an operation of feeding the recording medium 90 to the transfer position TP.

Thus, the image forming apparatus 5 forms a toner image of a predetermined color on the photoconductor drum 61 in the image forming unit 60, then transports the toner image to the transfer position TP through the medium transport path 85, and transfers the toner image to the recording medium 90.

Subsequently, the image forming apparatus 5 transports the recording medium 90 to which the toner image is transferred to the fixing unit 70 to perform a fixing operation.

Thus, the image forming apparatus 5 fixes the toner image to the recording medium 90 at the fixing processing portion FN in the fixing unit 70. The recording medium 90 subjected to the fixing operation is transported from the discharge port 55 to a medium receiver or a post-processing device, not illustrated, through the medium transport path 85.

With the above operation processes, the image forming apparatus 5 finishes its basic image forming operation.

The image forming apparatus 5 has an air intake structure that draws air outside the upper housing 50A forming part of the housing 50 into the interior space 51A in the upper housing 50A.

As illustrated in FIGS. 10A and 10B, the air intake structure may be any of the air intake structures 1A, 1B, 1C, and 1D according to the first to fourth exemplary embodiment, or a combination of any two or more of these.

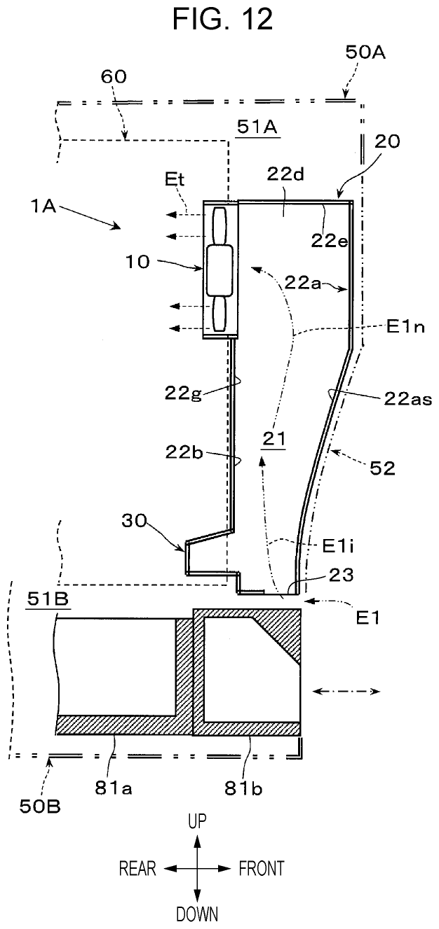

FIG. 12 schematically illustrates, by way of example, a structure including the air intake structure 1A according to the first exemplary embodiment (refer to, for example, FIG. 1) located at a predetermined position in the interior space 51A in the upper housing 50A, in a partial cross section.

The air intake structure 1A draws the air E1 outside the upper housing 50A to supply the air E1 to a predetermined portion of the image forming unit 60. Examples of the predetermined portion of the image forming unit 60 include, for example, a portion that is to be cooled, and an inlet of an air-flow structure.

In the air intake structure 1A, the blower 10 is located in the interior space 51A in the upper housing 50A to face the front of the image forming unit 60.

In the air intake structure 1A, the rear inner wall portion 22b defining the flow path 20 is formed from part of a partitioning plate that partitions off the image forming unit 60. The partitioning plate used as the rear inner wall portion 22b has the outlet port 24 (refer to FIG. 1) to which the blower 10 is attached.

In the air intake structure 1A, the front inner wall portion 22a defining the flow path 20 is formed from part of the inner surface of the openable covering 52 of the upper housing 50A. The air intake structure 1A includes, on the inner surface of the openable covering 52, the left inner wall portion 22c, the right inner wall portion 22d (refer to FIG. 1A), the upper-end inner wall portion 22e, and the lower-end inner wall portion 22f (refer to FIG. 1B) defining the flow path 20. The lower-end inner wall portion 22f has the inlet port 23.

Thus, the flow path 20 in the air intake structure 1A is completed when the openable covering 52 is closed to integrate the rear inner wall portion 22b, the front inner wall portion 22a, the left inner wall portion 22c, the right inner wall portion 22d, the upper-end inner wall portion 22e, and the lower-end inner wall portion 22f.

Instead, the flow path 20 may naturally be formed as an independent structure for the air intake structure 1A without using any of the components of the image forming apparatus 5.

As illustrated in FIG. 12, the air intake structure 1A includes the inlet port 23 located at the lower end portion of the upper housing 50A and facing a portion of the upper end portion of the lower housing 50B.

More specifically, the inlet port 23 is located to face part of the container 81 for the recording media 90 located to be drawable into the interior space 51B in the lower housing 50B. More specifically, the inlet port 23 is disposed to face, at a distance, an upper surface of a drawer pull 81b disposed in front of a body portion 81a of the container 81.

A gap is left between the lower ends of the openable covering 52 and the flow path 20 and the upper surfaces of the drawer pull 81b and the body portion 81a of the container 81 for ventilation.

The air intake structure 1A operates in accordance with the timing of at least the image forming operation of the image forming apparatus 5.

### Operation of Air Intake Structure

When the air intake structure 1A in the image forming apparatus 5 operates with rotation of the blower 10, as illustrated in FIG. 12, the air E1 outside the upper housing 50A is drawn in through the inlet port 23 into the flow path space 21 in the flow path 20 to serve as the suction air E1i.

Subsequently, in the air intake structure 1A, the suction air E1i flows through the flow path space 21 to the blower 10 to serve as the passing air E1n.

Finally, in the air intake structure 1A, the passing air E1n is directed by the blower 10 toward the image forming unit 60 in the interior space 51A in the upper housing 50A to serve as the efflux air Et.

At this time, in the air intake structure 1A, the air E1i drawn into the flow path space 21 through the inlet port 23 of the flow path 20 may contain at least one of water vapor and dust.

Also in this case, the air intake structure 1A includes the recessed portion 30 in the flow path 20. Thus, as described in the first exemplary embodiment, the at least one of water vapor and dust contained in the suction air E1i is trapped in the recessed portion 30, and is thus less likely to be transported through the blower 10 than in the structure including the air intake structure 1X according to the comparative example (FIG. 14) not including the recessed portion 30.

Thus, the image forming apparatus 5 including the air intake structure 1A directly discharges water vapor contained in the air E1, drawn in from the outside of the upper housing 50A, to the interior space 51A in the upper housing 50A. This structure reduces condensation of part of the water vapor which may cause a failure (including an image quality error) in the image forming operation. For example, water vapor may condense in the medium transport path 85. In this case, an image quality error such as a white patch may occur in an image formed on the recording medium 90. However, the image forming apparatus 5 reduces such an image quality error.

In the image forming apparatus 5 including the air intake structure 1A, dust contained in the air E1 taken from the outside of the upper housing 50A is directly discharged to the interior space 51A in the upper housing 50A. This structure reduces intrusion of part of the dust into the image forming unit 60 which may cause a failure (including an image quality error) in the image forming operation.

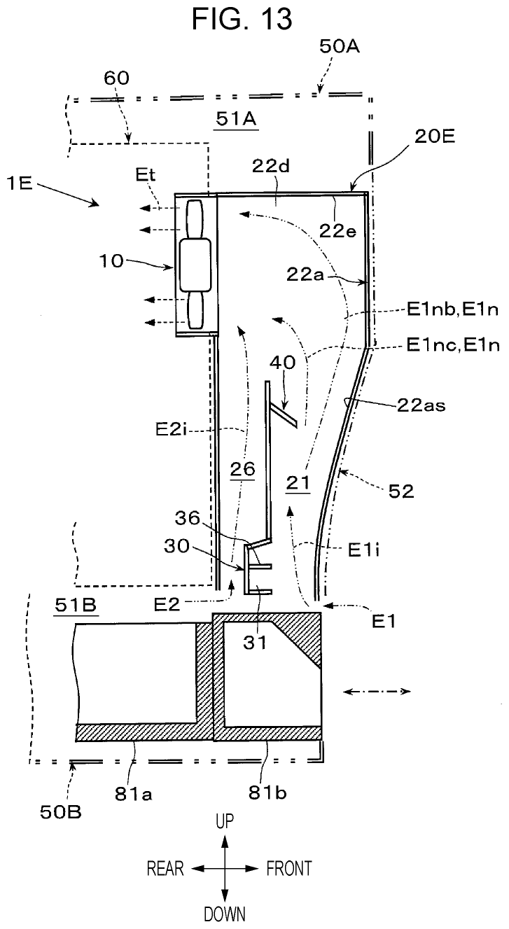

FIG. 13 schematically illustrates, by way of example, in a partial cross section, a structure including an air intake structure 1E obtained by combining, for example, the protrusion 40 according to the third exemplary embodiment with the air intake structure 1B according to the modification of the first exemplary embodiment (refer to, for example, FIG. 5). The intake structure 1E is located at a predetermined position in the interior space 51A in the upper housing 50A.

The air intake structure 1E additionally includes the protrusion 40 according to the third exemplary embodiment in the flow path 20B of the air intake structure 1B on the inner wall surface of the rear inner wall portion 22b, and the plate 36 (FIGS. 4A and 4B) according to the modification example of the first exemplary embodiment located in the recessed space 31 in the recessed portion 30. Thus, the air intake structure 1E employs a flow path 20E formed from a combination of these.

The image forming apparatus 5 including the air intake structure 1E also operates in the following manner when the blower 10 in the air intake structure 1E is driven to rotate.

As illustrated in FIG. 13, first, the air intake structure 1E draws the air E1 outside the upper housing 50A into the flow path space 21 in the flow path 20E through the inlet port 23 as the suction air E1i, and draws the air E2 in the interior space 51B in the lower housing 50B into the second flow path space 26 of the flow path 20E through the second inlet port 25 as the suction air E2i.

Subsequently, in the air intake structure 1E, the suction air E1i flows through the flow path space 21 to the blower 10 to serve as the passing air E1n. The suction air E2i flows through the second flow path space 26 to the blower 10.

Finally, in the air intake structure 1E, after the passing air E1n and the suction air E2i merge with each other in front of the blower 10 in the flow path 20E, the merged air is directed by the blower 10 toward the image forming unit 60 in the interior space 51A in the upper housing 50A to serve as the efflux air Et.

At this time, in the air intake structure 1E, the suction air E1i drawn into the flow path space 21 through the inlet port 23 of the flow path 20E may contain at least one of water vapor and dust.

On the other hand, the suction air E2i drawn into the second flow path space 26 through the second inlet port 25 of the flow path 20E is the air E2 in the interior space 51B in the lower housing 50B. Thus, compared to the air E1 outside the upper housing 50A or the air in the interior space 51A in the upper housing 50A, the suction air E2i is more likely to contain a smaller amount of water vapor and dust.

Even in this case, as described in, for example, the second or third exemplary embodiment, the air intake structure 1E including the recessed portion 30, the protrusion 40, or the plate 36 in the flow path 20E traps at least one of water vapor and dust contained in the suction air E1i with, for example, the recessed portion 30 or the protrusion 40, and thus further reduces transportation of the at least one of water vapor and dust through the blower 10 compared to the air intake structure 1X according to the comparative example (FIG. 14) including, for example, neither the recessed portion 30 nor the protrusion 40.

Thus, the image forming apparatus 5 including the air intake structure 1E also directly discharges at least one of water vapor and dust contained in the air E1 drawn in from the outside of the upper housing 50A to the interior space 51A in the upper housing 50A. This structure reduces intrusion of part of the dust or the water vapor into, for example, the image forming unit 60 which may cause a failure (including an image quality error) in the image forming operation.

### Other Modification Examples

Although the exemplary embodiments of the present disclosure have been described thus far, the present disclosure is not limited to the above first to fifth exemplary embodiments (including the modification example), and may be modified in various manners within the range not departing from the gist of the present disclosure. Thus, the present disclosure includes, for example, modification examples described below.

In the air intake structures 1A to 1E according to the first to fifth exemplary embodiments, at part of the front inner wall portion 22a in, for example, the flow path 20, the cross-sectional area of the flow path space 21 gradually increases from the inlet port 23 to at least a position in front of the blower 10. Instead, the cross-sectional area may increase stepwise.

Alternatively, at the front inner wall portion 22a in, for example, the flow path 20, the cross-sectional area of the flow path space 21 may remain substantially the same throughout from the inlet port 23 to at least a position in front of the blower 10. The flow paths including the flow path 20 may have a cross-sectional shape with, for example, curved corners instead of the flow path space 21 with a polygonal cross-sectional shape.

Instead of or in addition to the inner wall surface of the rear inner wall portion 22b defining the flow path space 21, the recessed portion 30 in, for example, the first exemplary embodiment may be located on at least one of the inner wall surfaces of the front inner wall portion 22a, the left inner wall portion 22c, and the right inner wall portion 22d defining the flow path space 21 at a portion adjacent to the inlet port 23 of the at least one inner wall surface.

In other words, the recessed portion 30 may be located at any position as long as allowing part of air drawn in through the inlet port 23 to enter the recessed space 31.

Instead, multiple recessed portions 30 may be disposed on the inner wall surface defining the flow path space 21 in the direction C in which air flows.

Instead of or in addition to the inner wall surface of the rear inner wall portion 22b defining the flow path space 21, the protrusion 40 according to, for example, the third exemplary embodiment may be located on at least one of the inner wall surfaces of the front inner wall portion 22a, the left inner wall portion 22c, and the right inner wall portion 22d defining the flow path space 21 at a portion adjacent to the inlet port 23 of the at least one inner wall surface.

In other words, the protrusion 40 may be located at any position as long as allowing part of air drawn in through the inlet port 23 to enter the dead-end space 43.

Instead, multiple protrusions 40 may be disposed at intervals on the inner wall surface defining the flow path space 21 in the direction C in which air flows.

In the first exemplary embodiment or another exemplary embodiment, multiple plates 36 may be disposed in the recessed space 31 in the recessed portion 30.

In the fifth exemplary embodiment, the image forming apparatus 5 is an image forming apparatus that forms monochrome images, but may be an image forming apparatus that forms multi-color images (color images).

The image forming apparatus 5 according to exemplary embodiments of the present disclosure is an image forming apparatus that employs a method for forming images with a developer. However, the image forming apparatus 5 may be an image forming apparatus that employs another image forming method as long as it forms images on the recording media 90. Other examples of an image forming method include a method for forming an image with a jet of ink (droplets) and a method for forming an image through ink transfer.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An air intake structure, comprising:
a blower;
a flow path that includes an inlet port that draws air and a flow path space connected to the inlet port to allow air drawn in through the inlet port to flow to the blower; and
a recessed portion that protrudes to an outer side of the flow path space at a portion of the flow path adjacent to the inlet port, the recessed portion having a recessed space opening to the flow path space.
   (((2)))

An air intake structure, comprising:
a blower;
a flow path that includes an inlet port that draws air and a flow path space connected to the inlet port to allow air drawn in through the inlet port to flow to the blower; and
a protrusion that protrudes to an inner side of the flow path space at a portion of the flow path in front of the blower, the protrusion including a slope inclined upstream in a direction in which the drawn air flows.
   (((3)))

The air intake structure according to (((1))) or (((2))), wherein in the flow path, the flow path space has a cross-sectional area that increases gradually or stepwise through the inlet port to at least a portion in front of the blower.

(((4)))

The air intake structure according to (((1))) or (((2))), wherein the inlet port is located below the blower.

(((5)))

The air intake structure according to (((1))), wherein the recessed portion is disposed on one of inner wall surfaces defining the flow path against which air drawn in through the inlet port hits first.

(((6)))

The air intake structure according to (((2))), wherein the protrusion is disposed on one of inner wall surfaces defining the flow path against which air drawn in through the inlet port hits first.

(((7)))

The air intake structure according to (((1))), wherein the recessed portion includes, in the recessed space, a plate extending in a direction crossing the direction in which the air drawn in through the inlet port flows.

(((8)))

The air intake structure according to (((1))) or (((7))), wherein the recessed space in the recessed portion has a depth that is larger than a height of an opening of the recessed space.

(((9)))

The air intake structure according to (((1))), (((7))), or (((8))), wherein a portion of the recessed portion on the inner wall surface defining the recessed space located on a side closer to the blower is a slope that is inclined toward the blower as the portion extends toward an opening of the recessed space.

(((10)))

The air intake structure according to (((1))), (((7))), (((8))), or (((9))), wherein the recessed portion includes a protrusion that blocks dripping of a waterdrop, at a bottom portion near an opening of the recessed space.

(((11)))

The air intake structure according to (((1))) or (((2))),
wherein the flow path includes:
   a second inlet port different from the inlet port; and
   a second flow path space that allows air drawn in through the second inlet port to merge with air drawn in through the inlet port at a position of the flow path in front of the blower.
      (((12)))

An image forming apparatus, comprising:
a housing; and
an air intake structure that draws air outside the housing into an interior space of the housing,
wherein the air intake structure is formed from the air intake structure according to (((1))).
   (((13)))

An image forming apparatus, comprising:
a housing; and
an air intake structure that draws air outside the housing into an interior space of the housing,
wherein the air intake structure is formed from the air intake structure according to (((2))).
   (((14)))

The image forming apparatus according to (((12))) or (((13))), wherein the inlet port in the air intake structure is disposed below the blower.

(((15)))

The image forming apparatus according to any one of (((12))) to (((14))),
wherein the flow path includes:
   a second inlet port different from the inlet port; and
   a second flow path space that allows air inside the housing and drawn in through the second inlet port to merge with air drawn in through the inlet port at a position of the flow path in front of the blower.

What is claimed is:

1. An air intake structure, comprising:
a blower;
a flow path that includes an inlet port that draws air and a flow path space connected to the inlet port to allow air drawn in through the inlet port to flow to the blower; and
a recessed portion that protrudes to an outer side of the flow path space at a portion of the flow path adjacent to the inlet port, the recessed portion having a recessed space opening to the flow path space.

2. An air intake structure, comprising:
a blower;
a flow path that includes an inlet port that draws air and a flow path space connected to the inlet port to allow air drawn in through the inlet port to flow to the blower; and
a protrusion that protrudes to an inner side of the flow path space at a portion of the flow path in front of the blower, the protrusion including a slope inclined upstream in a direction in which the drawn air flows.

3. The air intake structure according to claim 1, wherein in the flow path, the flow path space has a cross-sectional area that increases gradually or stepwise through the inlet port to at least a portion in front of the blower.

4. The air intake structure according to claim 2, wherein in the flow path, the flow path space has a cross-sectional area that increases gradually or stepwise through the inlet port to at least a portion in front of the blower.

5. The air intake structure according to claim 1, wherein the inlet port is located below the blower.

6. The air intake structure according to claim 2, wherein the inlet port is located below the blower.

7. The air intake structure according to claim 1, wherein the recessed portion is disposed on one of inner wall surfaces defining the flow path against which air drawn in through the inlet port hits first.

8. The air intake structure according to claim 2, wherein the protrusion is disposed on one of inner wall surfaces defining the flow path against which air drawn in through the inlet port hits first.

9. The air intake structure according to claim 1, wherein the recessed portion includes, in the recessed space, a plate extending in a direction crossing the direction in which the air drawn in through the inlet port flows.

10. The air intake structure according to claim 1, wherein the recessed space in the recessed portion has a depth that is larger than a height of an opening of the recessed space.

11. The air intake structure according to claim 1, wherein a portion of the recessed portion on the inner wall surface defining the recessed space located on a side closer to the blower is a slope that is inclined toward the blower as the portion extends toward an opening of the recessed space.

12. The air intake structure according to claim 1, wherein the recessed portion includes a protrusion that blocks dripping of a waterdrop, at a bottom portion near an opening of the recessed space.

13. The air intake structure according to claim 1,
wherein the flow path includes:
a second inlet port different from the inlet port; and
a second flow path space that allows air drawn in through the second inlet port to merge with air drawn in through the inlet port at a position of the flow path in front of the blower.

14. The air intake structure according to claim 2,
wherein the flow path includes:
a second inlet port different from the inlet port; and
a second flow path space that allows air drawn in through the second inlet port to merge with air drawn in through the inlet port at a position of the flow path in front of the blower.

15. An image forming apparatus, comprising:
a housing; and
an air intake structure that draws air outside the housing into an interior space of the housing,
wherein the air intake structure is formed from the air intake structure according to claim 1.

16. An image forming apparatus, comprising:
a housing; and
an air intake structure that draws air outside the housing into an interior space of the housing,
wherein the air intake structure is formed from the air intake structure according to claim 2.

17. The image forming apparatus according to claim 15, wherein the inlet port in the air intake structure is disposed below the blower.

18. The image forming apparatus according to claim 16, wherein the inlet port in the air intake structure is disposed below the blower.

19. The image forming apparatus according to claim 15,
wherein the flow path includes:
a second inlet port different from the inlet port; and
a second flow path space that allows air inside the housing and drawn in through the second inlet port to merge with air drawn in through the inlet port at a position of the flow path in front of the blower.

20. The image forming apparatus according to claim 16,
wherein the flow path includes:
a second inlet port different from the inlet port; and
a second flow path space that allows air inside the housing and drawn in through the second inlet port to merge with air drawn in through the inlet port at a position of the flow path in front of the blower.
